(19) United States
(12) Patent Application Publication
(10) Pub. No.: US 2016/0235049 A1
(43) Pub. Date: Aug. 18, 2016

(54) FRAMES FOR BLADED AND WEIGHTED FISHING LURES

(71) Applicant: David Lynn Thorne, Kaysville, UT (US)

(72) Inventor: David Lynn Thorne, Kaysville, UT (US)

(21) Appl. No.: 14/544,787

(22) Filed: Feb. 18, 2015

(51) Int. Cl. A01K 91/04; A01K 85/00

(52) U.S. Cl. CPC A01K 91/04; A01K 85/00

(57) ABSTRACT

A variety of novel frames for bladed fishing lures are disclosed. Generally, the frames provide for facile assembly and secure containment of associated blades while providing pivotal supporting structure for the blades. Weights for the lures are inferiorly and separately disposed relative to the blades to provide ballast and stability without markedly affecting blade and associated lure action. Careful attention is paid to frame construction to assure wire patterns are compatible with automatic wire winding machines and communicated forces are consistent with maintaining frame structure.

### CONTINUITY

This application is a Continuation-in-Part of U.S. patent application Ser. No. 14/120,871, titled BLADED FISHING LURE and filed Jul. 7, 2014; which is a Continuation-in-Part of U.S. patent application Ser. No. 13/999,509, titled LURE FISHING ASSEMBLY WITH WEIGHTED WIREFORM and filed Mar. 5, 2014; which is a Continuation of U.S. patent application Ser. No. 13/694,028, titled LURE FISHING ASSEMBLY WITH WEIGHTED WIREFORM and filed Oct. 22, 2012, now allowed as U.S. Pat. No. 8,733,012; which is a Continuation-in-Part of U.S. patent application Ser. No. 13/200,900, titled INTERCHANGEABLE BLADE AND LURE FISHING ASSEMBLY and filed Oct. 4, 2011, now allowed as U.S. Pat. No. 8,739,460; which is a Continuation-in-Part of U.S. patent application Ser. No. 12/387,024, titled BLADED FISHING LURE ASSEMBLY and filed Apr. 27, 2009; which is a Continuation-in-Part of U.S. patent application Ser. No. 11/656,099, titled FISHING LURE ASSEMBLY and filed Jan. 22, 2007, now abandoned, by David L. Thorne, which are made part hereof by reference.

### FIELD OF INVENTION

This invention relates to frames for bladed fishing lures. Herein, frames are defined to be infrastructure for blade, fishing hook assembly, line and, often, weight attachment sites for constructing a fishing lure.

### BACKGROUND AND RELATED ART

Frames for bladed lures are generally fishing lure components which are deemed necessary construction and attachment parts for other fish attracting lure parts. In this context, frames may be considered more a part of infrastructure than those parts which attract fish, although in some cases such may not be true. For these reasons, it is generally considered that the frame should be more hidden than revealed.

Even so, each frame is a very important part of a bladed fishing lure, providing communicating attachments to withstand strain of forces between fishing line and hook, to provide constraining bends to maintain associated blades in proper orientation while the lure is displaced through water and to have strategically disposed connecting elements for associated weights. In essence, frames may be considered fishing lure skeletons, supplying structure which provides features for attaching and orienting lure parts and for providing secure communication between fishhook and fishing line. In some cases, that communication through a frame may be differently oriented when a lure is “running” through water than when a rearward force is in applied to a hook or other lure part.

Frames are commonly made from wire, bent to provide attachment sites and supporting segments. For commercialization purposes, it is preferable that such wire frames be designed for automatic fabrication in an automatic wire bending machine. Perhaps one of the most salient features of a frame is an ability to promote simple and efficient lure assembly. In other lures, frames may be made from such processes as stamped metal or molded plastic.

One less noticeable role of a fishing lure frame may be to effect a guard which makes the lure less likely to gather moss or weeds when drawn through a marshy pond. Even so, commonly a frame provides the attachment site for a line and is thus a portion of the leading edge of a lure and a first contacting point when drawn through weeds. As contact with weeds in such environments is immanent it becomes compelling that each impacted weed be sloughed from the lure as attached weeds are all too potent in reducing lure effectiveness. For this reason, it is consequential for weed resistant lures to provide a leading portion of a frame which is designed to shed weeds.

### Definitions:

For purposes of this disclosure, the following definitions apply:
aft, adv, near, toward, or in the rear of a lure away from a line attachment
angle of attack, n, generally related to an predetermined angle of a blade relative to direction of pull of a lure through water, the angle of attack being an angle for achieving desired blade action
blade, n, a broad flattened part which is affixed to a portion of a fishing lure and which oscillates as the lure is propelled in water to provide a wake following therefrom; such a blade may be rigid or flexible, if flexible such a blade requires a supporting mast to withstand pressure from being displaced through water
centrally, adv, near, toward the center of gravity, syn: medially
distal, adj, (see also proximal) indicates the segment of a device normally away from a lure fishing line attachment
fishhook, n, a device, usually made of rigid metal wire, comprising a curved section which has a sharpened point on one end for catching a fish and a shank which comprises a substantially straight portion on an opposite end. Generally, the shank is ultimately affixed with an eyelet or other attachment providing for connecting line and other accouterments
fishhook assembly, n, a combination of a fishhook and other attributes associated with the fishhook for attaching the fishhook to a frame or wireform and for adding attractive components such as an artificial or natural bait
fore, adv, in, toward or adjacent to the front (i.e. forward near line attachment site)
inferior, adj, situated lower down or closer to the center of the earth than a referenced site
nose, n, the front, bow or proximal end of a lure
proximal, adj, indicates the segment of a device normally closely disposed relative to a line attachment of a lure
shank, n, a portion of a fishhook, the shank usually having a substantially straight portion, e.g. a portion which is associated with an aft curved portion of a fishhook and with a connecting link by which the fishhook is affixed to other fishing gear
substantially, adv, in a manner relating to the most or main part or characteristic of something, e.g. a substantially round ball which is known to be imperfect in roundness, but performs acceptably in its imperfect state
superior, adj, situated higher up or away from the center of the earth relative to a referenced site

### BRIEF SUMMARY AND OBJECTS OF THE INVENTION

In brief summary, this novel invention provides a basis for novel frame design which expedites bladed lure assembly, defines blade angle of attack when drawn through water, effectively resists strain of forces between fishhook and fishing line, provides for attaching a strategically disposed weight and, in relevant cases, provides structure for shedding mossy vegetation and weeds contacted in weed infested water.

Therefore, it is a primary object to provide a bladed lure frame which is readily formed in a wire bending machine.

It is a similar object to provide a bladed lure frame which is formed by metal stamping or plastic molding.

It is a paramount object to provide a bladed lure frame which is expeditious and efficacious in lure assembly.

It is a basic object to provide a bladed lure frame which can withstand strain of a large fish or snag.

It is an important object to provide a bladed frame which provides a site for affixing a fishing line which is consistent with blade and lure action requirements.

It is another important object to provide for strategic attachment of a weight associated with a bladed lure frame.

It is yet another object to provide a frame which provides a lure which communicates between along a first line between fishing line and fishhook when the lure is “running” and along a second line when strain occurs due attached fish or snag.

It is a primary object to provide a bladed lure frame which further provides leading edge which is weed resisting when drawn through water.

### BRIEF DESCRIPTION OF THE DRAWINGS

FIG. 1 is side elevation of a simple frame made from wire according to the present invention.

FIG. 2 is a side elevation of the frame seen in FIG. 1 with fishing luer parts affixed thereto to form a fishing assembly.

FIG. 3 is a perspective of the fishing assembly seen in FIG. 2.

FIG. 4 is side elevation of the fishing assembly seen in FIG. 3 with a portion of the frame bent to contain and orient the blade at a predetermined angle relative to the frame.

FIG. 5 is a perspective of the fishing assembly seen in FIG. 4.

FIG. 5A is a side elevation of a modified frame and associated fishing lure parts similar to the fishing luer assembly seen in FIG. 4 except for a distending segment of the modified frame where a weight and a fishhook are affixed.

FIG. 5B is a side elevation of the modified frame and fishing lure parts seen in FIG. 5A with a segment of the frame bent to contain and orient an associated blade at a predetermined angle for fishing.

FIG. 6 is a side elevation of a frame, similar to the frame of FIG. 4 already bent to contain and orient a blade for fishing.

FIG. 7 is a perspective of the frame and blade of FIG. 6.

FIG. 8 is a side elevation with a weighted lure molded to a portion of the frame seen in FIGS. 6 and 7.

FIG. 10 is a side elevation of a frame, blade and weighted lure similar to the frame and lure seen in FIG. 8.

FIG. 11 is a perspective of the frame, blade and lure see in FIG. 10.

FIG. 12 is a side elevation of a PRIOR ART frame with blade, weight, fishhook, fishing line and weight affixed thereto.

FIG. 13 is a side elevation of the frame, blade, weight, fishhook, fishing line and weight seen in FIG. 12 wherein the frame is distorted by force of pull of fishhook and fishing line.

FIG. 14 is a side elevation of a modified frame and other luer components seen in FIG. 12 wherein the frame comprises a clasp about a portion of the frame associated with fishing line attachment for securing the frame against distortion associated with strain resulting from opposing forces applied to fishing line and fishhook.

FIG. 15 is a side elevation of a frame which is formed to be angularly oriented by retarding force but without a force which causes such displacement.

FIG. 16 is a side elevation of the frame of FIG. 15 which is angularly displaced by a retarding force.

FIG. 17 is a side elevation of a multi-section frame centrally affixed to a weighted body with a simple fishhook affixed thereto and wherein the weighted body forms a part of the frame.

FIG. 18 is a side elevation of the frame of FIG. 19 with a more complex bait or soft body fishhook affixed in place of the simple fishhook.

FIG. 19 is a perspective of a fishing lure made according to the instant invention and comprising a frame made from material which may be stamped metal, molded plastic or other rigid frame fabricating material.

FIG. 20 is a side elevation of the fishing lure seen in FIG. 19.

### DETAILED DESCRIPTION OF THE ILLUSTRATED EMBODIMENTS

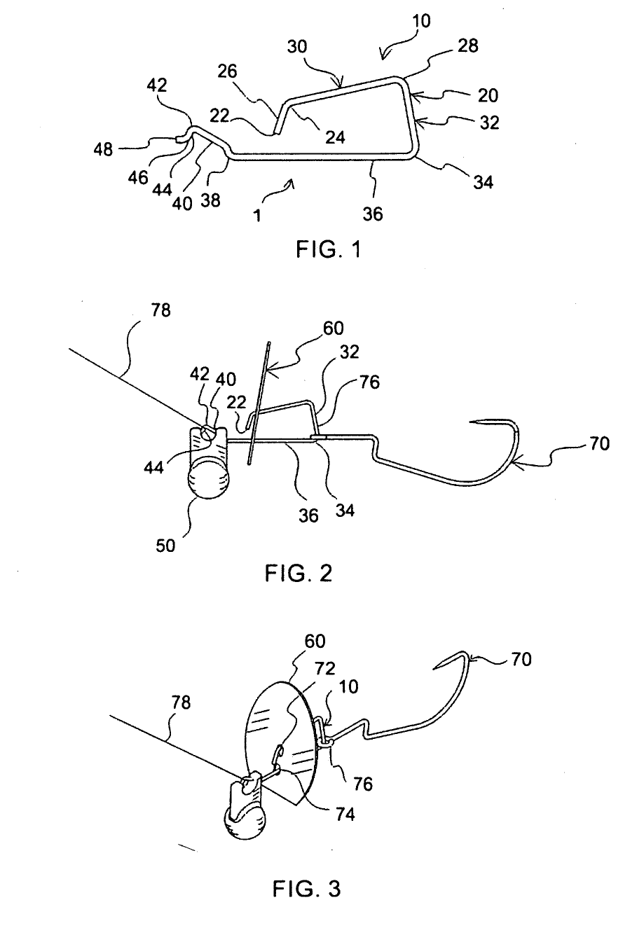

Reference is now made to the embodiments illustrated in FIGS. 1-20 wherein like numerals are used to designate like parts throughout. Primes of numbers, otherwise used without primes, are for designating labeled parts which are similar in form and/or function, but not identical, to those parts designated by the numbers without primes.

Reference is now made to FIG. 1 wherein a frame, generally referenced by the number 1 and understood to be a frame made according to the present invention made from a simple wireform 10 made for bladed lures according to the present invention is seen. Of course, a wireform may be embodied in other specific forms without departing from the spirit or essential characteristics thereof. As seen in FIG. 1, wireform 10 is simply formed by a series of bends in an otherwise straight wire 20. Wireform 10 is formed by bending wire 20 near a first end 22 (bend 24) to form a first segment 26 of predetermined length. A second bend 28 provides an upper blade support segment 30 and a downwardly distending segment 32. Bend 34 provides a forwardly distending segment 36 which is terminated at a bend 38. Extending upward at bend 38 is a segment 40 which is terminated at bend 42 which directs a short segment 44 angularly downward to a final forward bend 46 to produce a weight support arm 48. Aft of bend 42, wire 20 is further formed to provide a weight support segment which is also segment 40. (also see FIG. 2) Particular notice should be made of bend 34 which may be formed an acute angle between segments 32 and 36. A particular reason for an acute angle is disclosed hereafter.

A more complete fishing lure assembly is seen in FIGS. 2 and 3 wherein a weight 50 is affixed to wireform 10 about bend site 42. Note that bend 42 provides a fishing line 78 attachments site. A blade 60 and a fishhook 70 are threadedly affixed to wireform 10. As best seen in FIG. 3, blade 60 comprises a pair of mounting holes 72 and 74 and fishhook 70 comprises an eyelet 76 whereby assembly is facilely accomplished. Those who are skilled in the fishing lure assembly art well understand order and method of such assembly.

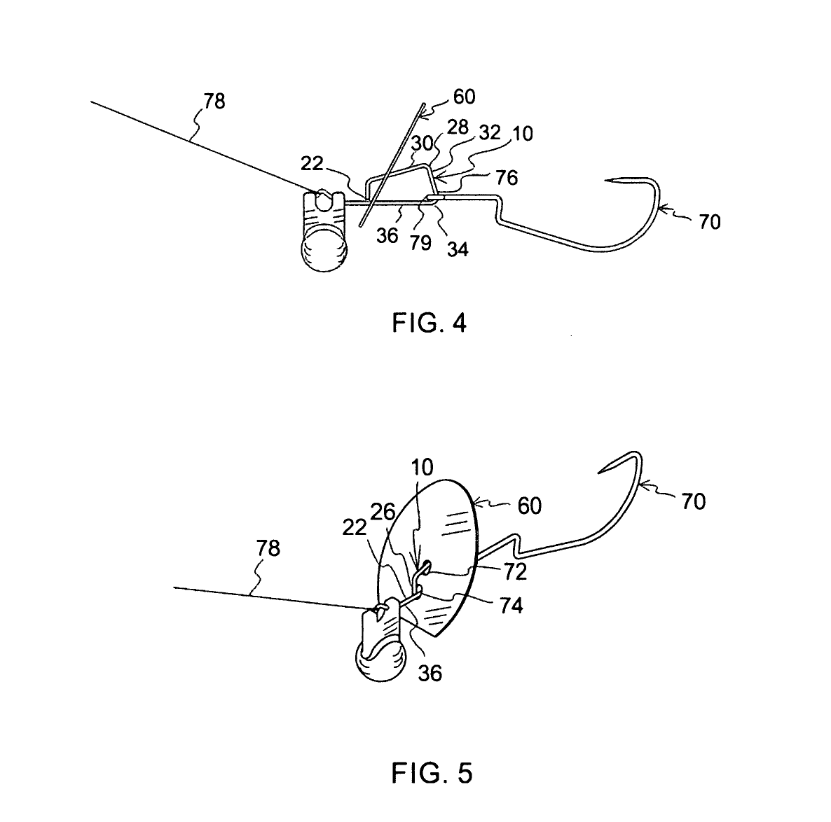

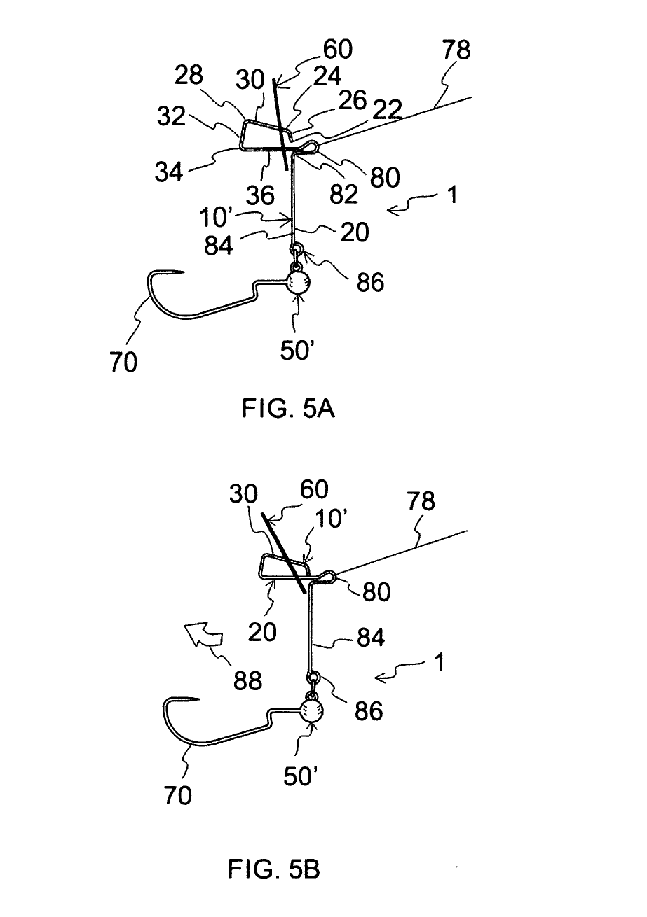

Note that, while assembly is complete in FIGS. 2 and 3, blade 60 and fishhook 70 are not securely affixed to wireform 10. Disassembly can, consequentially and inadvertently, occur in reverse order to assembly. However, using wire which can be further forcibly bent at bend 28, end 22 can be bent to near contact with segment 36 (see FIGS. 4 and 5). Of course for such to be useful as a fishing lure, wire 20 must be of sufficient rigidity and strength to withstand displacement forces during fishing. Note that the displacement of hole 72 relative to hole 74 and angular displacement of segment 30 relative to segment 36 defines an angle of attack for blade 60. In fishing lures associated with the present invention, angle of attack is preferred to be approximately 60° relative to the aft horizontal. Note also that other fishing lure parts may be substituted for fishhook 70 within the scope of the instant invention.

Further, with the disclosed angle of segment 32 relative to segment 36 (see FIGS. 2 and 4), line force from a fishing line 78 to fishhook 70 may be traced from line 78 along segment 36 to eyelet 76 and ultimately to fishhook 70. An acute angle 79 which is distended between segments 32 and 36 formed by bend 34 effectively provides a force communicating link between wireform 10 and fishhook 70 at acute bend 34 which has very little leverage to bend wireform 10 and displace end 22 from segment 36. Such is an important consideration because a small wire diameter wireform is an important feature of a fishing lure where the wireform is preferably not a desirably visible portion of a lure.

A similar type of blade 60 capture is seen in FIGS. 5A and 5B wherein a wire 20 is seen to be formed with a similarly beginning first end 22, segment 26, bend 24, segment 30, bend 28, segment 32, bend 34 and segment 36 to form a portion of a wireform 10′. However wireform 10′ comprises a loop 80 contiguously extending from segment 36. A bend 82 provides and inferiorly distending segment 84 which leads to a coupling 86 with an inferiorly disposed weight 50′. A fishhook 70 is securely affixed to weight 50′ and a fishing line 78 is affixed to loop 80. Again, note that a more elaborate fishing assembly may be affixed instead of fishhook 70. In this case, note that stress of pulling force applied to fishhook 70 is communicated to weight 50′ and along segment 84 to loop 80 and fishing line 44. That stress by nature of direction of pull, rotating segment 84, weight 50′ and fishhook 70′ angularly in direction of arrow 88 (see FIG. 5B), tends to close loop 80 permitting wire of lower rigidity to be used.

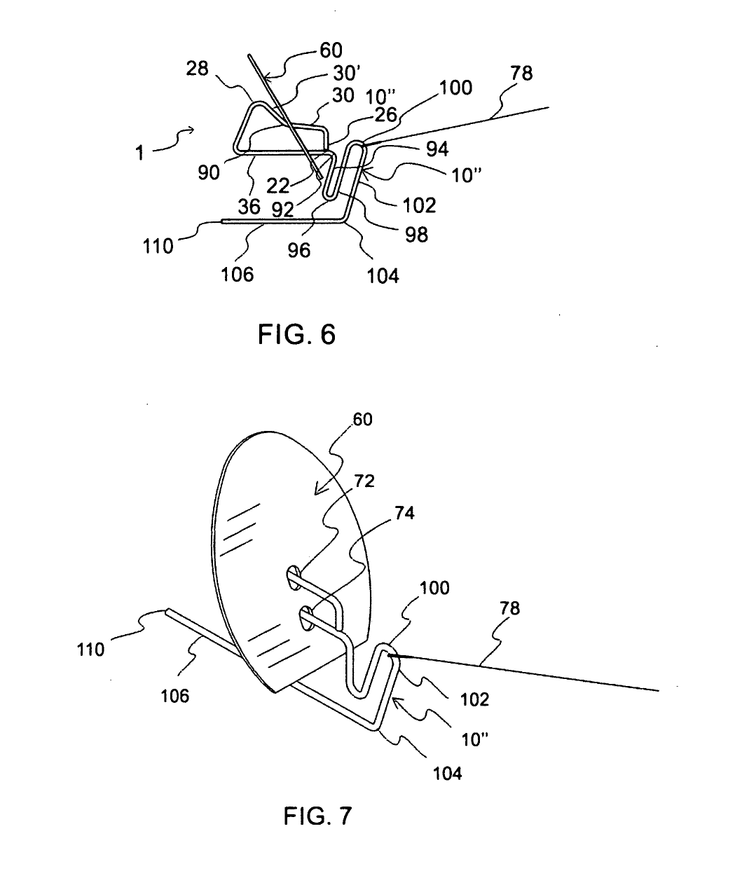

While previously disclosed wireforms 10 and 10′ have relied upon wire bend geometry for shape retention which is unaffected by pull stress between fishing line and fishhook assembly, a frame 1 comprising a wireform 10″ which depends for shape retention upon weight (and associated fishing lure assembly) is seen in FIGS. 6-7.

As seen in FIGS. 6 and 7, wireform 10″ is similar to wireforms 10 and 10′, but comprises a first additional bend 90 yielding an upwardly extending segment 30′ from segment 30 to rearward bend 28. Note that segment 30′ is bent at an angle which provides pivotal support for blade 60, assuring blade 60 is constrained to an appropriate angle of attack rather than relying on interaction between blade holes 72 and 74 and segments 30 and 36, respectively, for retention. Wireform 10″ is further differentiated from wireforms 10 and 10′ by a bend 92 forming descending segment 94 which ends in an upward bend 96 to initiate segment 98. Segment 98 is bounded by “U” shaped bend 100 which provides a tie point for fishing line 78. Extending downward from bend 100 segment 102 is terminated at bend 104 to provide rearwardly directed segment 106 which is further terminated at end 110.

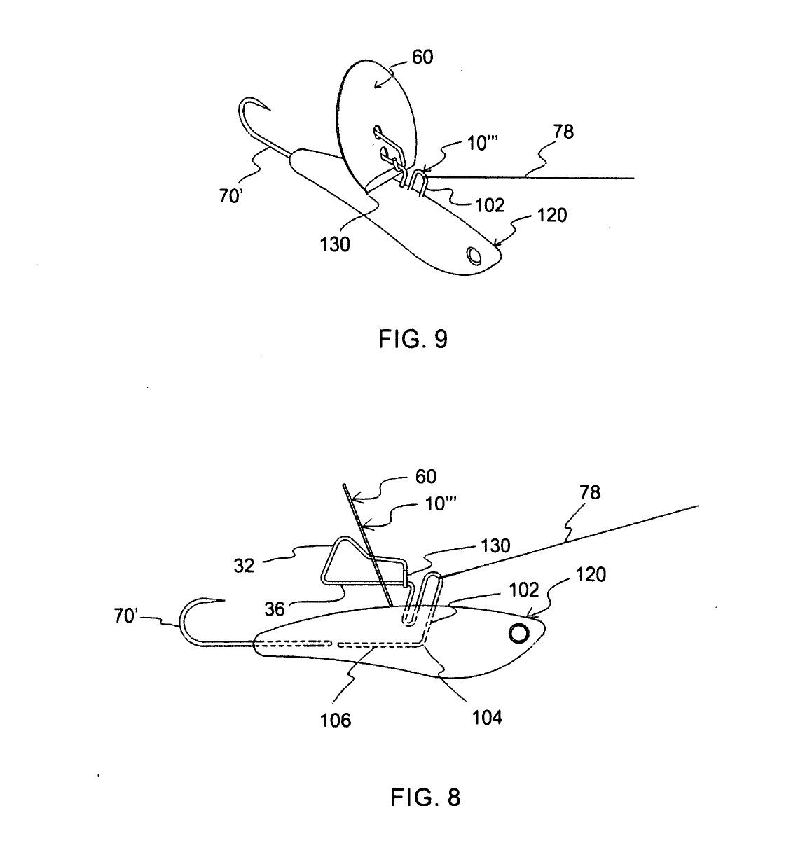

Key differences between wireforms 10 and 10′ and 10″ are the mode of support of blade 60, attachment of fishing line 78 and weights and lures although all comply with form and function of frame 1. Bend 90, distal from segment 30 to form segment 30″ in wireform 10″ provides a more secure support for blade action than the simpler wire contact along segment 30 in wireforms 10 and 10′. Fishing line 78 attachment and weight and lure attachment are more fully disclosed in FIGS. 8 and 9.

One further modification to wireform 10″ produces the wireform 10′″ seen in FIGS. 8 and 9. Wire 20 has a further bend to form a clasp 130 (see FIG. 8). Clasp 130 provides greater assurance of blade retention while affording an option for more ready blade 60 replacement and use of smaller diameter wire than required for wireforms 10, 10′ and 10″. In this case, though not necessarily so within the scope of the instant invention, a weight 120 is formed to resemble a fish and is molded over a portion of segment 102, bend 104 and segment 106. A fishhook 70′ is securely affixed to weight 120, preferably by overmolding. It may be noted that addition of a fishhook 70′ associated with weight 120 does not obviate attachment of a fishhook assembly to along segment 32 as seen in FIG. 2, although caution should be used to assure length of segment 36 affords operation without entanglement between two fishhook assemblies.

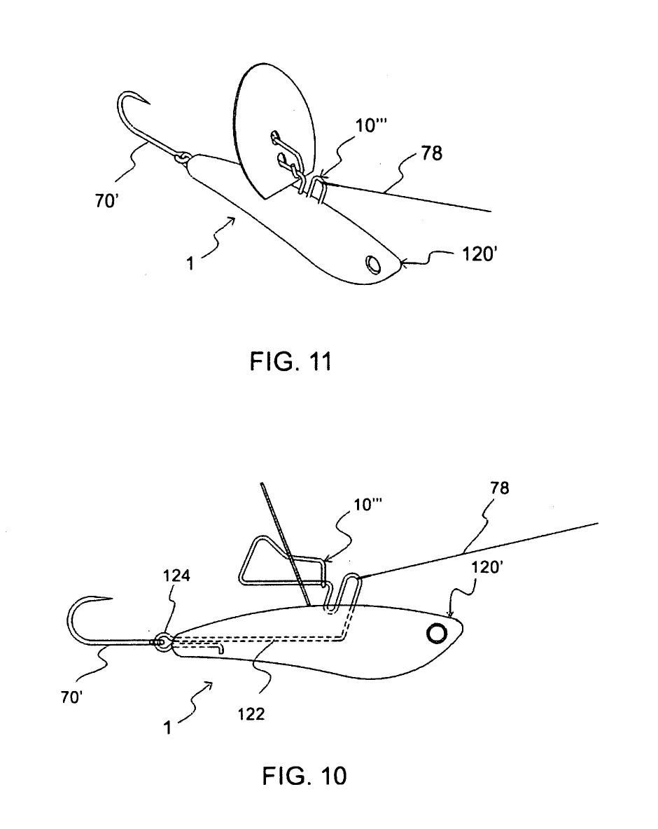

A variation for attaching an assembly, such as a fishhook 70′ to a wireform 10′″ is seen in FIGS. 10 and 11. While a segment 122 of wireform 10′″ is over molded in the same fashion as seen in FIGS. 8 and 9, a separate coupling ring wireform part 124 is affixed to weight 120′, which, in this case, is formed as a minnow, to permit oscillating movement of hook 70′.

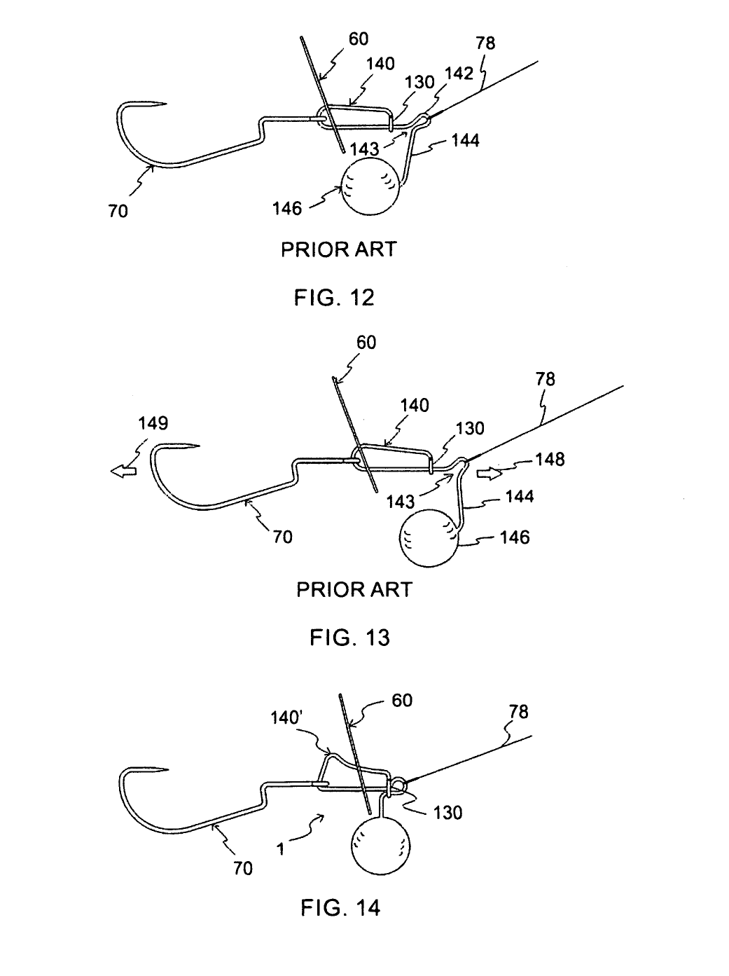

Reference is now made to FIGS. 12-16 wherein a clasp 130 is used to assure retention of wireform competence. PRIOR ART wireform configurations (referenced by 140) are seen in FIGS. 12 and 13. As seen in FIG. 12, fishing line 78 is tied to a loop 142 made about an open throat 143 of wireform 140. Wireform 140 has a downwardly distending shaft 144 affixed to a weight 146. As may be noted in FIG. 13, applying pulling forces in directions of arrow 148 (a pull on line 78) and arrow 149 (a pull on a hook 70) has a tendency to force throat 143 to open further, making wireform 140 less durable, reliable and desirable. By adding a clasp 130 to a wireform 140′ (see FIG. 14) stability is markedly increased thereby permitting wire of smaller diameter to be used in wireform 140′ than in wireform 140, for example.

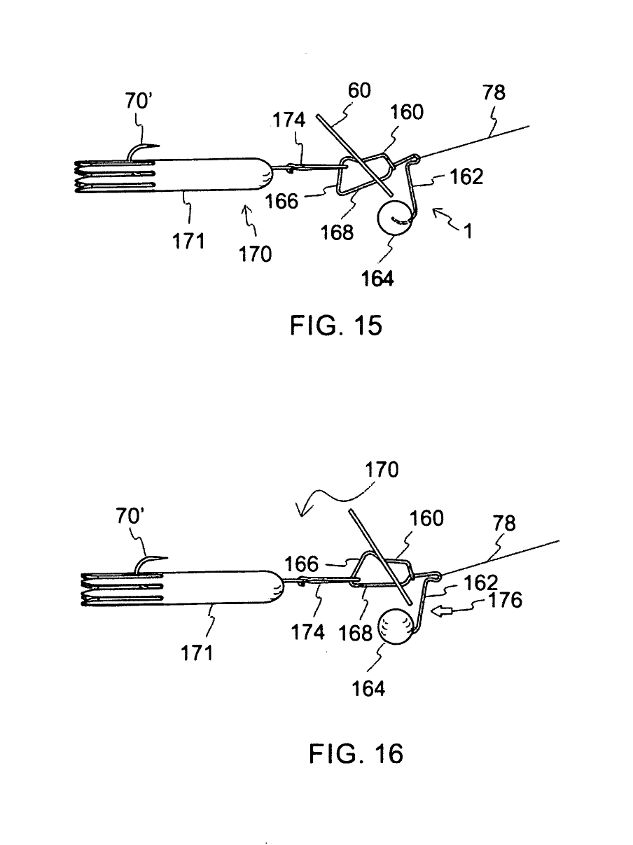

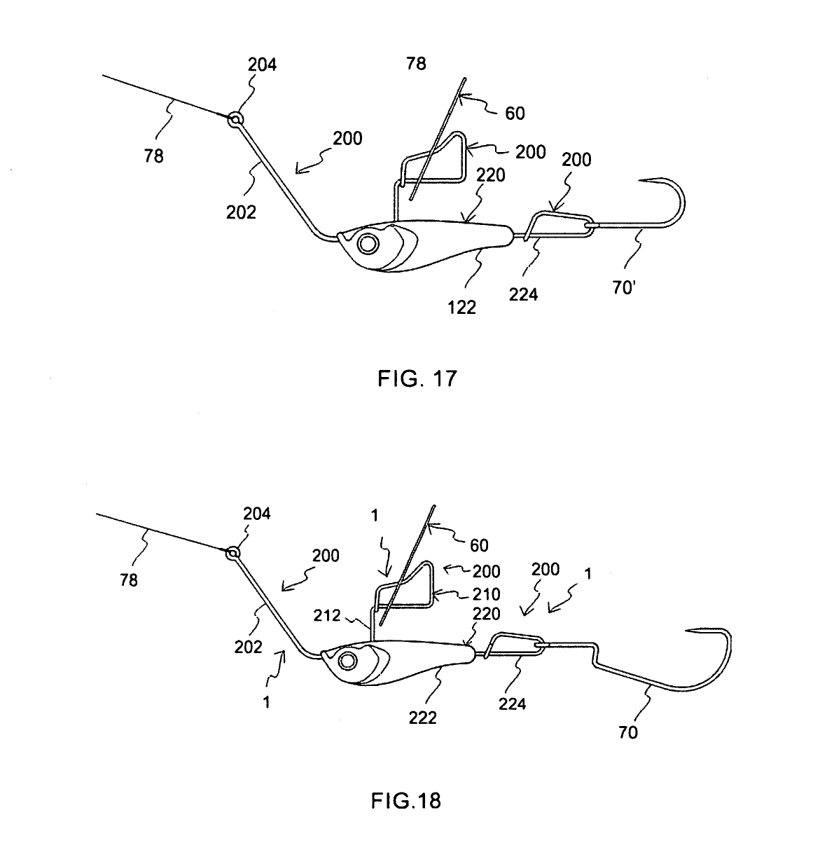

Frames can also be used as components which inherently improve weed resistance of lures. Two such frames (commonly identified by the number 1 as falling within the scope of the instant invention) are seen in FIGS. 15 and 16 and in FIGS. 71 and 18, respectively. Referring to FIG. 15, a wireform 160, similar to wireforms 10′ and 140, is seen to comprise a downwardly distending segment 162 to a weight 164. A rear segment 166 of wireform 160 is canted relative to a base segment 168 similarly to angulation of segment 32 to segment 36, seen in FIG. 8. A fishing lure combination 170 comprising a soft body 171 and hook 70, a linkage 174 to wireform 160, wireform 160, blade 60 and weight 164 are seen in a “running” mode in FIG. 15. However, when drag is applied to hook 70 in direction of arrow 176, seen in FIG. 16, the running mode is modified, as seen in FIG. 16, with segment 162 rotating to a more acute angle relative to a “running” direction. In this manner, forces induced upon hook 70 are linearly applied directly toward line 78. Any rotation of wireform 160 in direction of arrow 176 also displaces linkage 174 downward. The resulting angular shift of segment 162 provides an angle of attack of segment 162 which is consistent with an angle at which matter colliding with segment 162 is sloughed off, making lures using wireform 160 more weed resistant. Another weed resistant frame and lure combination is seen in FIGS. 17 and 18. In this case a wireform 200 may be made as separate parts. For example, a leading rod 202 with a fishing line 78 attachment ring 204, may be made of more sturdy yet resilient wire to provide a basis for a strong pull between fishing line 78 and an attached fishing lure assembly of which a fishing hook (e.g. 70 or 70′) represents a part. A centrally disposed wireform part 210 is similar in form and function to a blade supporting portion of wireform 10′″, see FIG. 8. A distending portion 212 is securely affixed to a weight 220, in this case. Note that weight 220 comprises the form a fish having a tail section 222. At section 222, another portion of wireform 200 comprises an anchored clasp 224 to which a fishhook, of which hooks 70 and 70′ are examples in FIGS. 17 and 18, respectively. Of course one skilled in fishing lure art well understands that more varied and complex fishing lure assemblies can be affixed to clasp 224.

Referring once more to leading rod 202, please note the approximate 60° angle distended by rod 202 from a “normal” running level of weight 220. This angle provides a slipping surface to contaminating weeds or other material which would otherwise be affixed, pulled along to deteriorate lure effectiveness. Of course the angle can be varied within the scope of the invention, but care should be taken to make the angle sufficiently acute to slough off impacted material. As rod 202 is subject to being stressed by attached fish and snags, care should be taken to select wire material, such as hardened steel, having appropriate cross sectional girth which will return to an original disposition upon release of such stress.

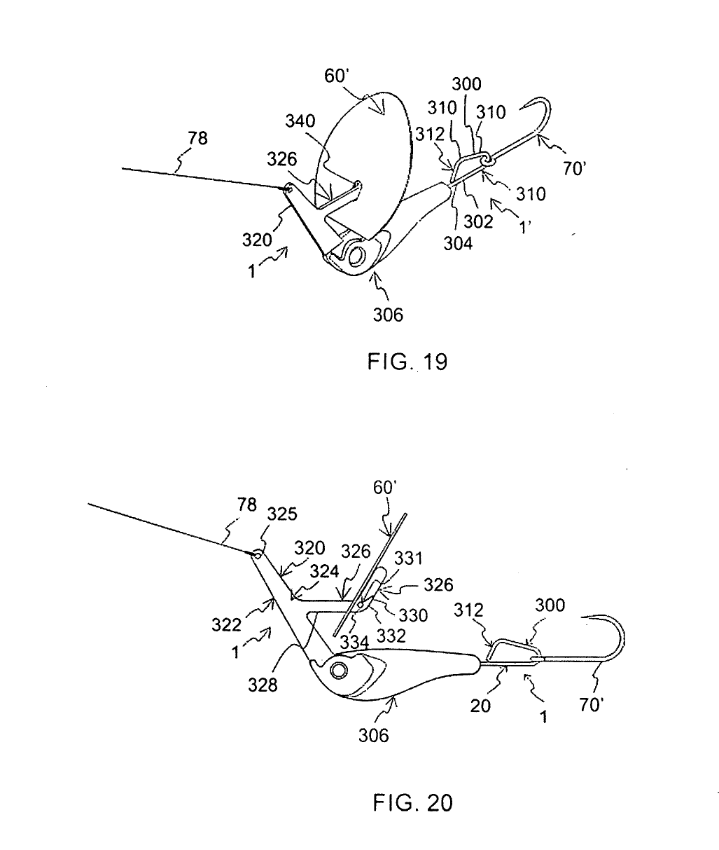

Reference is now made to FIGS. 19 and 20 wherein a frame 1 made according to the present invention having a portion constructed without a wire 20 is seen. Note, that in this case, a wire 20, as seen in FIG. 19, is used to form a frame part 300 of an attachment segment 302 for a hook 70′. Of course, other hooks or even additional fishing lure assemblies may be affixed to part 300 within the scope of the invention. Segment 302 comprises an anchoring leg 304 whereby part 300 is affixed to a weighted lure 306 (preferably by overmolding). From a stern section of leg 304, wire 20 comprises a series of bends, generally numbered 310 to form a fastener 312 for hook 70′. In this case, wire 20 must be sufficiently rigid to resist strain of force placed upon hook 70′. Of course a clasp, such as clasp 130, see FIG. 14, may be used to reduce material strength requirements of wire 20.

At the forward end of frame 1, a frame part 320, best seen in FIG. 20 is seen. In conjunction with lure 306, frame part 320 presents an angulated moss or weed shedding front edge 322 to water based impediments. Leading edge 322 is provided by structure of frontal leg 324 which comprises a superiorly disposed hole 325 whereat a fishing line 78 is affixed. A trailing section 326 comprises two parts, level extension 328 and upwardly angled extension 330. At a juncture 332 of extensions 328 and 330 a hole 331 is provided for a blade containment pin 334. Note, in this embodiment of the instant invention, a blade 60′, which is geometrically similar to blade 60, comprises a slot 340 (see FIG. 15) through which section 326 is threaded in assembly. Angulation of extension 330 supports blade 60′ at a desired angle of attack. Pin 334 is secured in place after displacing blade 60′ about section 326 to capture and secure blade 60′. Those skilled in fishing lure art well understand method and specification required for making part 320. As well, part 320 is preferably securely affixed to weighted lure 306 by overmolding, although other means of attachment may be used within the scope of the invention.

Frames, being skeletal parts of lures, have important charges. For a bladed lure, made according to the instant invention, each frame 1 should:

1. Provide a secure and direct unbreaking communication between fishing line and lure assembly, especially under stress of a fish or snag.

2. Provide support for an oscillating blade while keeping the blade disparate from an associated weight used for ballast.

3. Provide means for facile assembly of the blade upon the frame and for surely affixing the blade at an appropriate attack angle after assembly.

4. Provide a communicating link between fishing line (e.g. fishing line 78) and lure and blade which assures “true” running of the lure when displaced through water. True running should be interpreted to mean substantially level displacement while permitting blade action to be communicated to fishing lure assemblies.

5. Provide other functions such as weed resistant shields when so designated.

Careful review of the figures should be made to ascertain design for a selected frame from which a fishing lure is to be made.

The present embodiment should be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A bladed fishing lure frame comprising:
a fishing line attachment facet;
structure for threaded assembly and loosely but securely affixing and constraining a blade whereby the blade, comprising at least one opening where through said structure is displaced and assembled to the frame and a geometric configuration by which the blade is displaced side-to-side when displaced through water, communicates oscillatory movement to an associated fishing lure assembly;
further structure for affixing a fishing lure assembly comprising a fishhook such that blade displacement affects lure motion and force of distal pull of snag or fish is directly aligned along said structure to said facet;
said frame comprising additional structure whereby a weight being disparate from the blade and having a center of gravity inferiorly disposed relative to the blade is affixed to the frame to provide fishing lure stability while being displaced through water.

2. A bladed fishing lure frame according to claim 1 comprising structure made from wire.

3. A bladed fishing lure frame according to claim 1 comprising structure made from material selected from a group of materials comprising plastic and stamped metal;

4. A bladed fishing lure frame according to claim 1 comprising an attachment site whereby the fishing lure assembly is disposed aft of the blade.

5. A bladed fishing lure frame according to claim 1 comprising a weight and fishing lure combination separately and inferiorly disposed relative to the blade.

6. A bladed fishing lure according to claim 1 comprising a weight and fishing lure combination separately

7. A bladed fishing lure frame according to claim 1 comprising wireform which is disposed in a first state for assembling the blade to the frame and in a second state wherein the blade is loosely but securely affixed for fishing.

8. A bladed fishing lure frame according to claim 7 comprising a clasp for securing the wireform in the second state and for releasing the wireform to the first state for blade maintenance.

9. A bladed fishing lure frame according to claim 1 comprising a fishing hook assembly affixed to said frame aft of the blade.

10. A bladed fishing lure frame according to claim 1 comprising a fishing hook assembly affixed aft of the weight.

11. A frame for a bladed fishing lure comprising a plurality of bends and associated segments comprising:
a. a site whereat a fishing line is affixed to said frame;
b. a blade attachment where by the blade is loosely yet securely affixed to said frame and supported at a predetermined angle of attack when displaced through water by the fishing line to communicate yaw and angular motion to said frame while producing a wake in the water aft of the blade;
c. a weight attachment site whereat a weight is securely affixed disparate from the blade such that the weight provides orientation determining ballast for said frame without contacting with blade to interfere with the motion thereof.

12. A bladed fishing lure made according to claim 11 comprising a fishing lure assembly affixed to said frame aft of the blade

13. A bladed fishing lure made according to claim 11 comprising a fishing lure assembly disposed aft of the weight.

14. A bladed fishing lure made according to claim 11 comprising a frame segment angled and disposed for sloughing debris afflicted by a plurality of water borne objects comprising moss, weeds and other plant life upon said frame.

15. The frame according to claim 11 further comprising a clip where by the blade is securely affixed to the frame.

16. The frame according to claim 11 comprising but a single wire fashioned to provide said bends and segments.
